(19) United States
(12) Patent Application Publication
(10) Pub. No.: US 2026/0328294 A1
(43) Pub. Date: Oct. 22, 2026

(54) FLUID FLOW CONTROL APPARATUS AND METHOD

(71) Applicant: Human Hydrology Devices, Houston, TX (US)

(72) Inventors: Erin Elena Mohr, Chicago, IL (US); Tyler Devin Panian, Naperville, IL (US); Samuel Robert Zschack, Palatine, IL (US); Jed-Sian Cheng, Houston, TX (US); Mostafa Jubayar Hasan, Sugar Land, TX (US)

(73) Assignee: Human Hydrology Devices, Houston, TX (US)

(21) Appl. No.: 19/653,333

(22) Filed: Apr. 21, 2026

Related U.S. Application Data
(60) Provisional application No. 63/792,788, filed on Apr. 22, 2025.

(51) Int. Cl. F16K 7/06

(52) U.S. Cl. CPC F16K 7/06; F16K 2200/30

(57) ABSTRACT

An apparatus may include first, second, and third ports, a body including a central passage, a tube, and a pinch valve. In a first position of the pinch valve, at least a top portion of a plug of the pinch valve may extend into the third port and block a first fluid path that is between the first port and the third port and passes through an opening in the tube, and the pinch valve does not block a second fluid path that is between the first port and the second port and passes through the tube. In a second position, the pinch valve may connect the first fluid path, and a pusher of the pinch valve may push down on the tube and block the second fluid path. Inserting a device into the third port may transition the pinch valve from the first position to the second position.

### CROSS-REFERENCE TO RELATED APPLICATION

The present application claims the benefit of priority to U.S. Provisional Application Ser. No. 63/792,788, filed on Apr. 22, 2025, which is incorporated herein by reference in its entirety.

### FIELD OF THE DISCLOSURE

This disclosure relates to systems and methods for controlling fluid flow. For example, this disclosure relates to systems and methods that may be used to drain fluid from and inject fluid to a subject with the same device.

### BACKGROUND

Existing bladder drainage system typically include a Foley catheter connecting the bladder of a patient to a urine-collecting bag via a drainage port and tubing. If there is a need to irrigate the bladder or administer a medication to the bladder, the system needs to be manually disconnected at the drainage port site to connect a syringe to the Foley catheter to have access to the bladder. Alternatively, if the drainage bag is not disconnected from the Foley catheter, the drainage bag pathway needs to be clamped so that a syringe can flush solution through a three-way stopcock device to the bladder. Other existing fluid flow control systems have similar structures.

### SUMMARY

Existing fluid flow control systems and methods (e.g., existing bladder drainage systems, existing feeding tube systems, and existing infusion systems) suffer from various disadvantages. For example, these systems are not user friendly or reliable, are prone to user error, and can decrease the cleanliness and sterility of the systems, which can potentially cause patient harm and the loss of patient samples. In addition, debris and clots in the existing systems can cause system dysfunction and damage, and contaminate the patient's sample or instilled medium (e.g., medication, sterile water, antibiotics, chemo agent, or nutrition).

Some aspects of the present disclosure may overcome one or more issues associated with conventional fluid flow control systems and methods. Some aspects of the present disclosure may provide novel fluid flow control systems and methods that are easier to use and can avoid system dysfunction (e.g., caused by debris and clots) and cross-contamination between the systems and the fluid. In some aspects, the fluid flow control system may provide a closed system that enables the system to stay sterile without exposure to air and outside elements, which may reduce the risk of contamination and/or reduce handling steps.

One aspect of the invention may provide an apparatus for controlling fluid flow. The apparatus may include a first port, a second port, a third port, a body, a tube, and a pinch valve. The first port may be configured to be coupled to a first channel. The second port may be configured to be coupled to a second channel. The third port may be configured to be coupled to a device defining a third channel. The third port may include a female fitting. The body may include a central passage connecting the first port, the second port, and the third port. The tube may extend from the first port to the second port through the central passage of the body. A portion of the tube in the central passage may include an opening. The pinch valve may include a plug and a pusher. The apparatus may be configured to be in a first state if a male fitting of the device is not inserted in the female fitting of the third port. The pinch valve may be configured to be in a first position if the apparatus is in the first state. At least a top portion of the plug of the pinch valve may be configured to extend into the third port in a direction away from the central passage and block a first fluid path when the pinch valve is in the first position, and the pinch valve may be configured to not block a second fluid path when the pinch valve is in the first position. The first fluid path may be between the first port and the third port and may pass through the opening in the tube. The second fluid path may be between the first port and the second port and may pass through the tube. The apparatus may be configured to be in a second state if the male fitting of the device is fully inserted in the female fitting of the third port. The pinch valve may be configured to be in a second position if the apparatus is in the second state. The pinch valve may be configured to connect the first fluid path in the second position, and the pusher of the pinch valve may be configured to push down on the tube and block the second fluid path when the pinch valve is in the second position. The apparatus may be configured such that inserting the male fitting into the female fitting of the third port causes the apparatus to transition from the first state to the second state.

In some aspects, the pusher may include a stem and an engagement portion, and the engagement portion may be configured to push down on the tube and block the second fluid path when the pinch valve is in the second position. In some aspects, the stem of the pusher may extend into the plug. In some aspects, the engagement portion may be a tapered engagement portion.

In some aspects, the plug may cover a top surface of the stem. In some alternative aspects, the plug may not cover a top surface of the stem. In some aspects, the plug may be configured such that, when the male fitting of the device is inserted in the female fitting of the third port, the male fitting of the device pushes on the stem and does not push directly on the plug. In some aspects, the plug may include an elastomer, and the stem may include a rigid material.

In some aspects, the body may include one or more guides configured to guide movement of the pusher when the apparatus transitions from the first state to the second state.

In some aspects, the apparatus may include a spring configured to bias the pinch valve toward the first position of the pinch valve. In some aspects, the body may include one or more projections, the pinch valve may include a flange that may include a surface that faces away from the third port, and, when the pinch valve is in the second position, the spring may be compressed between the one or more projections and the flange of the pinch valve.

In some aspects, the tube may be configured to bias the pinch valve toward the first position of the pinch valve.

In some aspects, when the pinch valve is in the second position, a top of the plug may be below a thread on an external surface of the female fitting of the third port in a direction toward the central passage.

In some aspects, a top surface of the plug may be uneven, and the uneven top surface of the plug may be configured to facilitate connection of the first fluid path when the pinch valve is in the second position.

In some aspects, a bottom of the third port may include a slanted surface configured to facilitate the first fluid path.

In some aspects, the first and second fluid paths may be bi-directional.

Another aspect of the invention may provide a method for controlling fluid flow using an apparatus. The apparatus may include a first port, a second port, a third port, a body including a central passage, a tube, and a pinch valve including a plug and a pusher. The method may include connecting the first port to a first channel. The method may include connecting the second port to a second channel. The method may include connecting the third port to a device defining a third channel, the third port may include a female fitting, and connecting the third port to the device may include fully inserting a male fitting of the device into the female fitting of the third port. The first port, the second port, and the third port may be connected to each other via the central passage. The tube may extend from the first port to the second port through the central passage of the body. A portion of the tube in the central passage may include an opening. The apparatus may be in a first state before the third port is connected to the device. The pinch valve may be configured to be in a first position if the apparatus is in the first state. The apparatus may be configured to be in a second state if the male fitting of the device is fully inserted in the female fitting of the third port. The pinch valve may be configured to be in a second position if the apparatus is in the second state. Connecting the third port to the device may cause the apparatus to transition from the first state to the second state. When the pinch valve is in the first position, at least a top portion of the plug of the pinch valve may extend into the third port in a direction away from the central passage and block a first fluid path that may be between the first port and the third port and pass through the opening in the tube. When the pinch valve is in the first position, the pinch valve may not block a second fluid path that may be between the first port and the second port and pass through the tube. When the pinch valve is in the second position, the pinch valve may connect the first fluid path. When the pinch valve is in the second position, the pusher of the pinch valve may push down on the tube and block the second fluid path.

In some aspects, the pusher may include a stem and an engagement portion, and the engagement portion may be configured to push down on the tube and block the second fluid path when the pinch valve is in the second position. In some aspects, the method may further include using one or more guides of the body to guide movement of the pusher when the apparatus transitions from the first state to the second state. In some aspects, the method may further include using a spring and/or the tube to bias the pinch valve toward the first position of the pinch valve. In some aspects, the method may further include using an uneven top surface of the plug to facilitate connection of the first fluid path when the pinch valve is in the second position. In some aspects, the method may further include using a slanted surface of a bottom of the third port to facilitate the first fluid path. In some aspects, the first and second fluid paths may be bi-directional.

Further variations encompassed within the systems and methods are described in the detailed description of the invention below.

### BRIEF DESCRIPTION OF THE DRAWINGS

The accompanying drawings, which are incorporated herein and form part of the specification, illustrate various, non-limiting aspects of the present invention. In the drawings, like reference numbers indicate identical or functionally similar elements.

FIGS. 1 and 2 illustrate side and perspective views, respectively, of an exemplary apparatus for controlling fluid flow according to some aspects.

FIGS. 3A and 3B illustrate cross-sectional side and cross-sectional front views, respectively, of an exemplary apparatus with spring in a first state according to some aspects.

FIGS. 4A and 4B illustrate cross-sectional side and cross-sectional front views, respectively, of the exemplary apparatus with spring in a second state according to some aspects.

FIGS. 5A and 5B illustrate cross-sectional side and cross-sectional front views, respectively, of an exemplary apparatus in a first state according to some alternative aspects.

FIGS. 6A and 6B illustrate cross-sectional side and cross-sectional front views, respectively, of the exemplary apparatus in a second state according to some alternative aspects.

FIG. 7 is a flowchart illustrating an exemplary process for controlling fluid flow according to some aspects.

The figures herein are for illustrative purposes only and are not necessarily drawn to scale.

### DETAILED DESCRIPTION

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or aspects so described and illustrated.

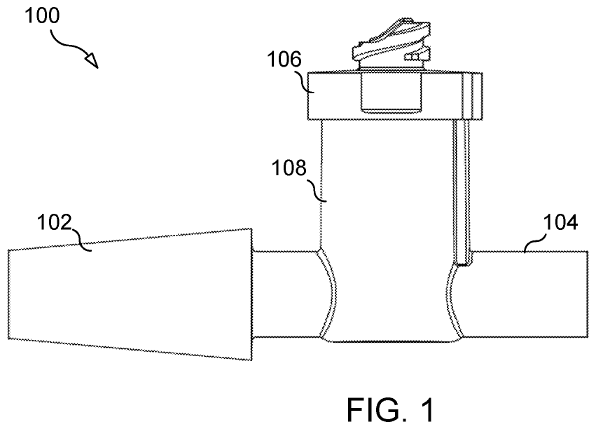

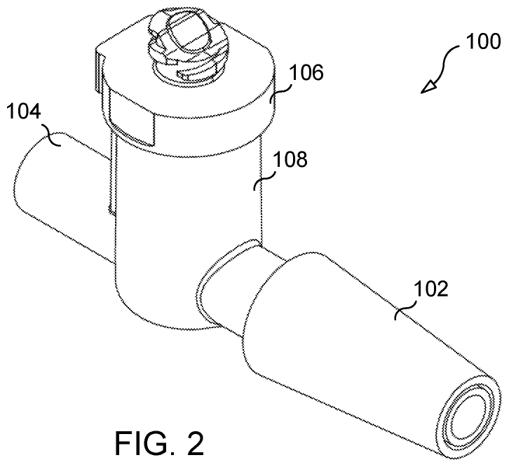

FIGS. 1 and 2 show an exemplary apparatus 100 for controlling fluid flow. As used herein, the term “fluid” may include both liquids and gases. The apparatus may include a first port 102, a second port 104, and a third port 106. The first port 102 may be configured to be coupled to a first channel. The second port 104 may be configured to be coupled to a second channel. The third port 106 may be configured to be coupled to a third channel. In some aspects, each of the first, second, third channels may be fluidically connected to a container or a subject. In some aspects, the first channel may be, for example, a catheter that extends to a portion of a patient's body. In some aspects, the second channel may be, for example, a drainage tube, which may receive fluid from a subject's body. The fluid from the subject's body may be a bodily fluid such as, for example and without limitation, urine, amniotic fluid, aqueous humour, vitreous humour, bile, blood, blood serum, breast milk, cerebrospinal fluid, cerumen (earwax), chyle, chyme, endolymph, perilymph, exudates, feces, male ejaculate, female secretions, gastric acid, gastric juice, lymph, mucus (including nasal drainage and phlegm), pericardial fluid, peritoneal fluid, pleural fluid, pus, rheum, saliva, sebum (skin oil), semen, sputum, synovial fluid, sweat, tears, vaginal secretion, vomit, or other bodily fluid, or a mixture thereof. In some aspects, the third channel may be defined by a device. In some aspects, the device may be, for example, a syringe or another fluid delivery device (e.g., a feeding tube or an IV bag with a connector), and the device may selectively administer or collect fluids. In some aspects, the apparatus 100 may include a body 108 disposed between the first port 102, the second port 104, and the third port 106.

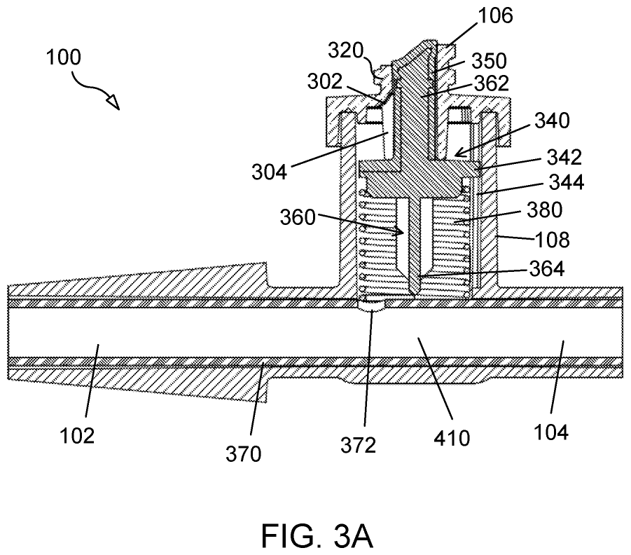

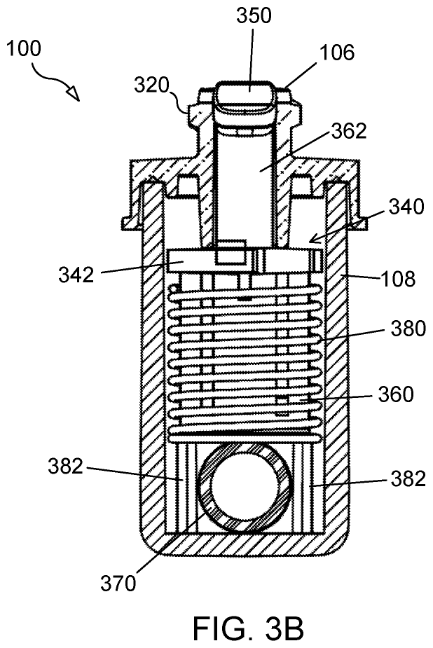

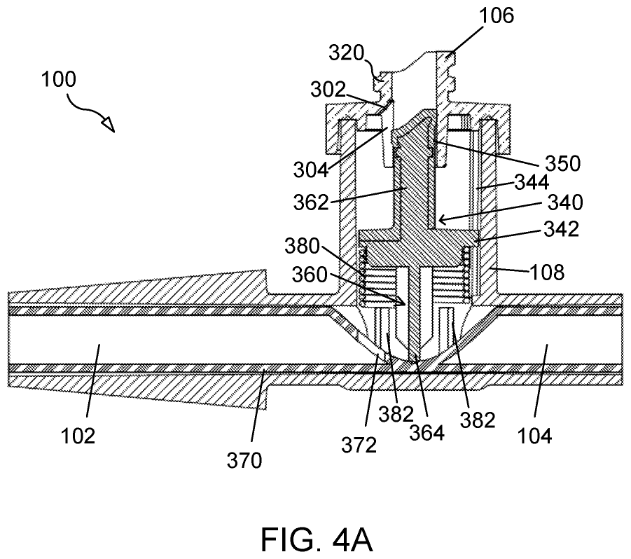

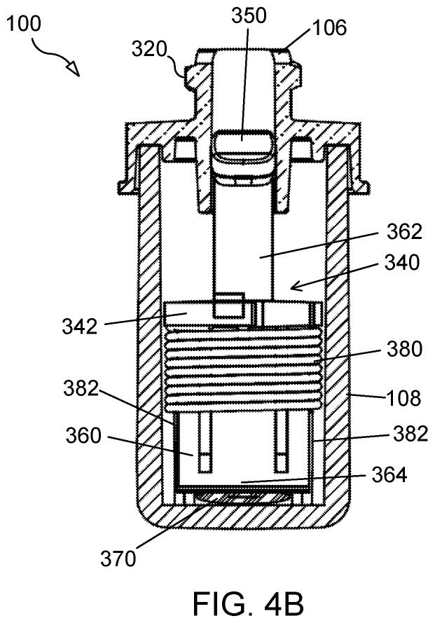

FIGS. 3A and 4A show cross-sectional side views of the apparatus 100, and FIGS. 3B and 4B show cross-sectional front views of the apparatus 100. In some aspects, as shown in FIGS. 3A and 4A, the body 108 of the apparatus 100 may include a central passage, which may connect the first port 102, the second port 104, and the third port 106 such that fluid may flow therebetween. In some aspects, the apparatus 100 may define a first fluid path between the first port 102 and the third port 106 and a second fluid path between the first port 102 and the second port 104.

In some aspects, as shown in FIGS. 3A-4B, the apparatus 100 may include a tube 370. In some aspects, the tube 370 may extend from the first port 102 to the second port 104 through the central passage of the body 108. In some aspects, a portion of the tube 370 in the central passage may include an opening 372. In some aspects, the first fluid path, which is between the first port 102 and the third port 106, may pass through the opening 372 in the tube 370. In some aspects, the second fluid path, which is between the first port 102 and the second port 104, may pass through the tube 370.

In some aspects, as shown in FIGS. 3A-4B, the apparatus 100 may include a pinch valve 340. In some aspects, the apparatus 100 may selectively transition between (1) a first state (shown in FIGS. 3A and 3B) in which the pinch valve 340 in a first position blocks the first fluid path between the first port 102 and the third port 106 and does not block the second fluid path between the first port 102 and the second port 104 and (2) a second state (shown in FIGS. 4A and 4B) in which the pinch valve 340 in a second position blocks the second fluid path between the first port 102 and the second port 104 and does not block the first fluid path between the first port 102 and the third port 106. In some aspects, the transition from the first state to the second state may occur when a male fitting of a device (e.g., a syringe) is inserted into a female fitting 320 of the third port 106, and the transition from the second state to the first state may occur when the male fitting of the device is removed from the female fitting 320 of the third port 106. In some aspects, the transition may be caused manually or automatically.

In some aspects, as shown in FIGS. 3A-4B, the pinch valve 340 may include a plug 350 and a pusher 360. In some aspects, as shown in FIGS. 3A and 3B, the apparatus 100 may be configured to be in the first state if a male fitting of the device is not inserted in the female fitting 320 of the third port 106. In some aspects, the pinch valve 340 may be configured to be in the first position if the apparatus 100 is in the first state. In some aspects, as shown in FIGS. 3A and 3B, at least a top portion of the plug 350 of the pinch valve 340 may extend into the third port 106 in a direction away from the central passage and block the first fluid path between the first and third ports 102 and 106 when the pinch valve 340 is in the first position, and the pinch valve 340 may be configured to not block the second fluid path between the first and second ports 102 and 104 when the pinch valve 340 is in the first position.

In some aspects, as shown in FIGS. 4A and 4B, the apparatus 100 may be configured to be in the second state if the male fitting of the device is fully inserted in the female fitting 320 of the third port 306. In some aspects, the pinch valve 340 may be configured to be in the second position if the apparatus 100 is in the second state. In some aspects, as shown in FIGS. 4A and 4B, the pinch valve 340 may be configured to connect the first fluid path between the first and third ports 102 and 106 in the second position, and the pusher 360 of the pinch valve 340 may be configured to push down on the tube 370 and block the second fluid path between the first and second ports 102 and 104 when the pinch valve 340 is in the second position.

In some aspects, as shown in FIGS. 3A-4B, the pusher 360 may include a stem 362 and an engagement portion 364. In some aspects, as shown in FIGS. 4A and 4B, the engagement portion 364 may be configured to push down on the tube 370 and block the second fluid path between the first and second ports 102 and 104 when the pinch valve 340 is in the second position. In some aspects, as shown in FIGS. 3A and 4A, the stem 362 of the pusher 360 may extend into the plug 350. In some aspects, as shown in FIGS. 3A-4B, the engagement portion 364 may be a tapered engagement portion.

In some aspects, as shown in FIGS. 3A and 4A, the body 108 may include one or more guides 344 configured to guide movement of the pusher 360 when the apparatus 100 transitions between the first and second states. In some aspects, the one or more guides 344 may include one or more channels, strips, and/or grooves that run vertically (or substantially vertically) along the surface of the body 108. In some aspects, as shown in FIGS. 3A and 4A, the pinch valve 340 may include a flange 342, and the one or move guides 344 may interact with the flange 342 to guide the movement of the pusher 360 when the apparatus 100 transitions between the first and second states.

In some aspects, the plug 350 may cover at least a portion (or all) of the stem 362 of the pusher 360. In some aspects, as shown in FIGS. 3A and 3B, when the apparatus 100 is in the first state and the pinch valve 340 is in the first position, at least a top portion of the plug 350 may extend into the third port 106 in a direction away from the central passage and seal the third port 106. In some aspects, the plug 350 may include an elastomer (e.g., silicone), and the stem 362 may include a rigid material such as, for example and without limitation, plastic (e.g., polycarbonate) and/or metal. In some aspects, as shown in FIGS. 3A and 4A, the plug 350 may cover the top surface of the stem 362 and at least a portion (or all) of the side surfaces of the stem 362. In some aspects in which the plug 350 covers the top surface of the stem 362 and at least a portion (or all) of the side surfaces of the stem 362, the plug 350 may act as both a radial and axial seal when the pinch valve 340 is in the first position as shown in FIGS. 3A and 3B. In some aspects in which the plug 350 covers the top surface of the stem 362 and at least a portion (or all) of the side surfaces of the stem 362, the plug 340 may be configured such that, when the male fitting of the device is inserted in the female fitting 320 of the third port 106, the male fitting of the device contacts and pushes directly on the plug 350.

However, it is not required that the plug 350 cover the top surface of the stem 362, and, in some alternative aspects, the plug 350 may cover at least a portion (or all) of the side surfaces of the stem 362 but not cover the top surface of the stem 362 such that the top surface of the stem 362 is exposed. In some alternative aspects in which the plug 350 covers at least a portion (or all) of the side surfaces of the stem 362 but not cover the top surface of the stem 362, the plug 350 may act as a radial seal when the pinch valve 340 is in the first position. In some alternative aspects in which the plug 350 covers at least a portion (or all) of the side surfaces of the stem 362 but not cover the top surface of the stem 362, the pinch valve 340 may be configured such that, when the male fitting of the device is inserted in the female fitting 320 of the third port 106, the male fitting of the device contacts and pushes directly on the exposed top surface of the stem 362 but neither contacts nor pushes on the plug 350.

In some aspects, as shown in FIGS. 3A-4B, a top surface of the plug 350 may be uneven. In some aspects, as shown in FIGS. 4A and 4B, the uneven top surface of the plug 350 may be configured to facilitate connection of the first fluid path between the first and third ports 102 and 106 when the pinch valve 240 is in the second position.

In some aspects, as shown in FIGS. 3A and 4A, the bottom of the third port 106 may include a notch or opening 304, and the notch 304 may include a slanted surface 302. In some aspects, the first fluid path, which is between the first port 102 and the third port 106, may pass through the notch 304 in the bottom of the third port 106. In some aspects, the notch 304 (including the slanted surface 302) may be configured to facilitate the first fluid path.

In some aspects, the female fitting 320 may be a female fitting of a sealing taper. In some aspects, the male fitting of the device may be a male fitting of a sealing taper. In some aspects, the male fitting of the device may be a male fitting of a syringe. In some aspects, the third port 106 may include a thread. The thread may be configured to engage a complementary thread on a device (e.g., a syringe). For example, the female fitting 320 and thread may together define a female portion of a sealing lock, which may be configured to engage a male portion of a Luer lock of a device. In some aspects, as shown in FIGS. 4A and 4B, when the pinch valve 340 is in the second position, a top of the plug 350 may be below a thread on an external surface of the female fitting 320 of the third port 106 in a direction toward the central passage.

In some aspects, as shown in FIGS. 3B-4B, the body 108 may include one or more projections 382. In some aspects, the projections 382 may hold the tube 370 in place within the central passage of the body 108. In some aspects, as shown in FIGS. 3A-4B, the pinch valve 340 may include a flange 342 that includes a surface that faces away from the third port 106.

In some aspects, as shown in FIGS. 3A-4B, the apparatus 100 may include a spring 380 configured to bias the pinch valve 340 toward the first position of the pinch valve 340. In some aspects, as shown in FIGS. 4A and 4B, when the pinch valve 340 is in the second position, the spring 380 may be compressed between the one or more projections 382 of the body 108 and the flange 342 of the pinch valve 340.

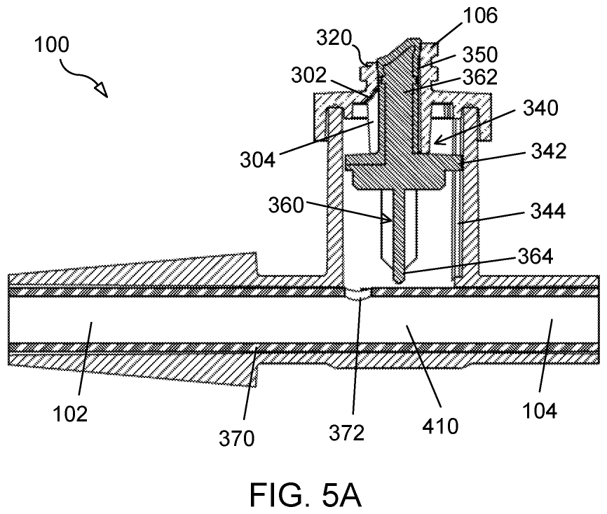

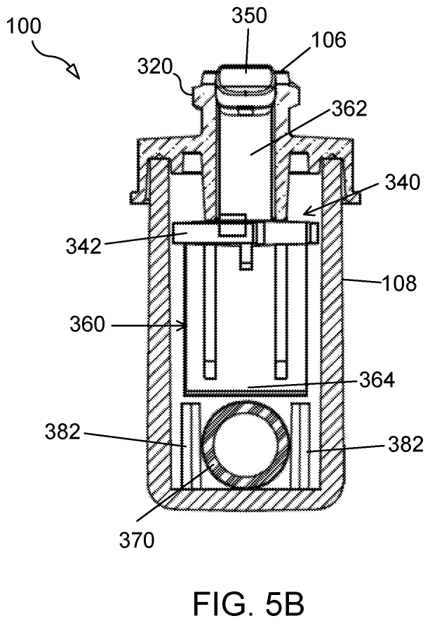

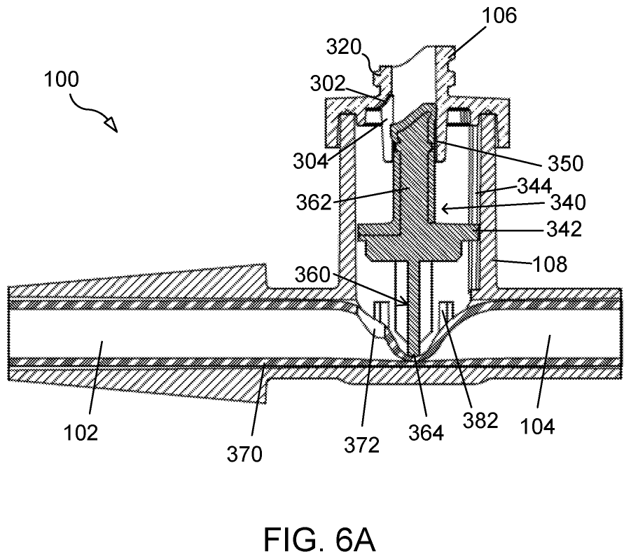

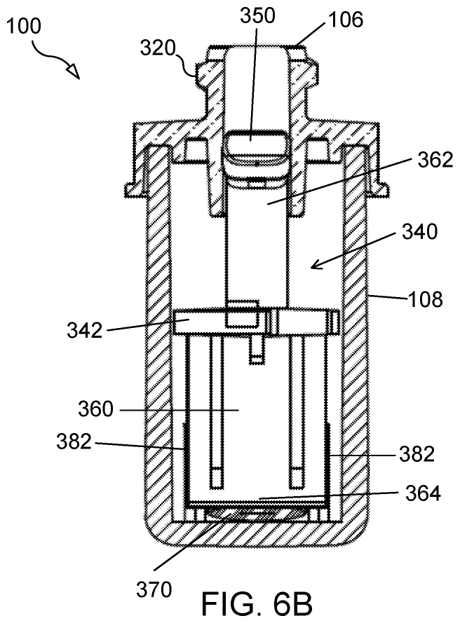

However, the apparatus 100 does not require the spring 380 to bias the pinch valve 340 toward the first position of the pinch valve 340. For example, in some alternative aspects, as shown in FIGS. 5A-6B, the apparatus 100 may not include the spring 380, and the tube 370 may be configured to bias the pinch valve 340 toward the first position of the pinch valve 340 (e.g., the elasticity of the tube 370 may bias the pinch valve 340 toward the first position of the pinch valve 340). Similar to FIGS. 3A and 3B, FIGS. 5A and 5B illustrate cross-sectional side and cross-sectional front views, respectively, of the apparatus in the first state according to some alternative aspects in which the apparatus 100 does not include the spring 380. Similar to FIGS. 4A and 4B, FIGS. 6A and 6B illustrate cross-sectional side and cross-sectional front views, respectively, of the apparatus 100 in the second state according to some alternative aspects in which the apparatus 100 does not include the spring 380.

In some aspects, one or more of the first and second fluid paths of the apparatus 100 may be bidirectional. That is, in some aspects, the structure of the apparatus 100 may be such that, in the first state (with the pinch valve 340 in the first position) as shown in FIGS. 3A and 3B (or FIGS. 5A and 5B), fluid may be capable of flowing along the second fluid path from the first port 102 to the second port 104, and fluid may be capable of flowing along the second fluid path from the second port 104 to the first port 102. Similarly, in the second state (with the pinch valve 340 in the second position) shown in FIGS. 4A and 4B (or FIGS. 6A and 6B), fluid may be capable of flowing along the first fluid path from the first port 102 to the third port 106, and fluid may be capable of flowing along the first fluid path from the third port 106 to the first port 102.

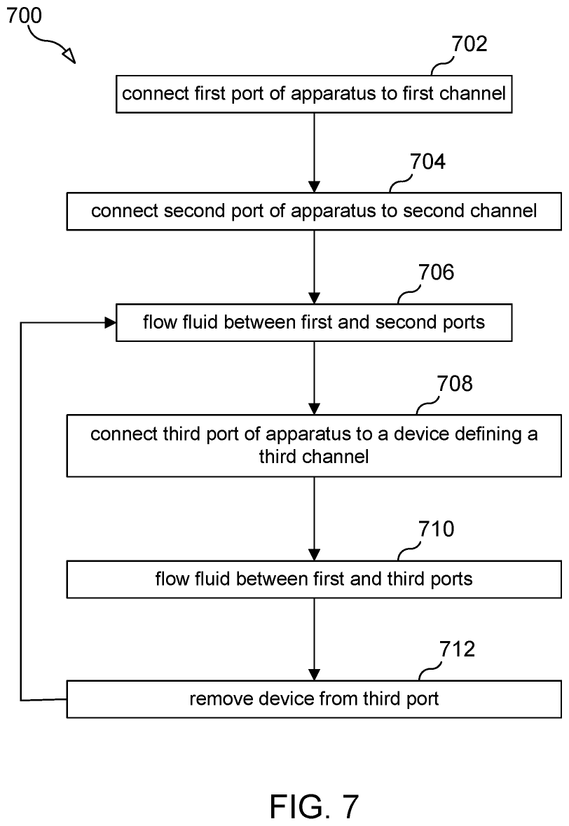

FIG. 7 is a flowchart illustrating a process 700 for controlling fluid flow according to some aspects. In some aspects, one or more of the steps of the process 700 may be performed using the apparatus 100. In some aspects, as shown in FIG. 7, the process 700 may include a step 702 of connecting the first port 102 of the apparatus 100 to a first channel and a step 704 of connecting the second port 104 of the apparatus 100 to a second channel.

In some aspects, the process 700 may include a step 706 of using the apparatus 100 to flow fluid between the first and second ports 102 and 104 (e.g., from the first channel to the second channel or from the second channel to the first channel). In some aspects, in step 706, the fluid may flow along the second fluid path that is between the first and second ports 102 and 104 and passes through the tube 370. In some aspects, in step 706, the apparatus 100 may be in the first state (with the pinch valve 340 in the first position) as shown in FIGS. 3A and 3B (or FIGS. 5A and 5B). In some aspects, when the pinch valve 340 is in the first position as shown in FIGS. 3A and 3B (or FIGS. 5A and 5B), at least a top portion of the plug 350 of the pinch valve 340 may extend into the third port 106 in a direction away from the central passage of the body 108, and the pinch valve 340 may block the first fluid path, which is between the first and third ports 102 and 106 and passes through the opening 372 in the tube 370. In some aspects, when the pinch valve 340 is in the first position, the pinch valve 370 does not block the second fluid path.

In some aspects, as shown in FIG. 7, the process 700 may include a step 708 of connecting the third port 106 to a device defining a third channel. In some aspects, the third port 106 may include a female fitting 320, and connecting the third port 106 to the device in step 708 may include fully inserting a male fitting of the device into the female fitting 320 of the third port 106. In some aspects, connecting the third port 106 to the device in step 706 may cause the apparatus 100 to transition from the first state shown in FIGS. 3A and 3B (or FIGS. 5A and 5B) to the second state (with the pinch valve 340 in the second position) shown in FIGS. 4A and 4B (or FIGS. 6A and 6B). In some aspects, as shown in FIGS. 4A and 4B (or FIGS. 6A and 6B), when the pinch valve 340 is in the second position, the pinch valve 340 may connect the first fluid path that is between the first and third ports 102 and 106 and passes through the opening 372 in the tube 370. In some aspects, as shown in FIGS. 4A and 4B (or FIGS. 6A and 6B), when the pinch valve 340 is in the second position, the pusher 360 of the pinch valve 340 may push down on the tube 370 and block the second fluid path that is between the first and second ports 102 and 104 and passes through the tube 370.

In some aspects, as shown in FIG. 7, the process 700 may include a step 710 of using the apparatus 100 to flow fluid between the first and third ports 102 and 106 (e.g., from the first channel to the third channel or from the third channel to the first channel). In some aspects, the apparatus 100 may be configured to be the second state as shown in FIGS. 4A and 4B (or FIGS. 6A and 6B) in step 710 with the male fitting of the device fully inserted in the female fitting of the third port 106.

In some aspects, as shown in FIG. 7, the process 700 may include a step 712 of removing the device from the third port 106 of the apparatus. In some aspects, removing the device from the third port 106 in step 712 may cause the apparatus 100 to transition from the second state shown in FIGS. 4A and 4B (or FIGS. 6A and 6B) to the first state shown in FIGS. 3A and 3B (or FIGS. 5A and 5B). In some aspects, the process 700 may proceed from step 712 to step 706.

As used herein, a “sample” may contain a tissue, a cell (e.g., a live cell), cell debris, a bodily fluid from a subject (e.g., a patient), a cell culture, or a cell culture from a bodily fluid. In some aspects, the sample may be a bodily fluid. A bodily fluid may be urine, amniotic fluid, aqueous humour, vitreous humour, bile, blood, blood serum, breast milk, cerebrospinal fluid, cerumen (earwax), chyle, chyme, endolymph, perilymph, exudates, feces, male ejaculate, female secretions, gastric acid, gastric juice, lymph, mucus (including nasal drainage and phlegm), pericardial fluid, peritoneal fluid, pleural fluid, pus, rheum, saliva, sebum (skin oil), semen, sputum, synovial fluid, sweat, tears, vaginal secretion, vomit, or other bodily fluid, or a mixture thereof.

The terms “subject,” “individual,” and “patient” are used interchangeably herein to refer to a vertebrate. A subject may be a mammal, such as a human. Examples of mammals include rodents (e.g., rats, mice), rabbits, primates (e.g., human), farm animals (cows), sport animals (e.g., horses), and pets (e.g., dogs, cats).

The term “exemplary” is used herein to mean serving as an example, instance, or illustration. Any aspect or design described herein as “exemplary” is not necessarily to be construed as preferred or advantageous over other aspects or designs.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the process described above and illustrated in the drawings is shown as a sequence of steps, this was done solely for the sake of illustration. Accordingly, it is contemplated that some steps may be added, some steps may be omitted, the order of the steps may be re-arranged, and some steps may be performed in parallel. For example, although step 702 is shown as being performed before step 704, this is not required, and, in some alternative aspects, step 702 may be performed after step 704, or steps 702 and 704 may be performed in parallel.

What is claimed is:

1. An apparatus for controlling fluid flow, the apparatus comprising:
a first port configured to be coupled to a first channel;
a second port configured to be coupled to a second channel;
a third port configured to be coupled to a device defining a third channel, the third port comprising a female fitting;
a body comprising a central passage connecting the first port, the second port, and the third port;
a tube extending from the first port to the second port through the central passage of the body, wherein a portion of the tube in the central passage comprises an opening; and
a pinch valve comprising a plug and a pusher;
wherein:
the apparatus is configured to be in a first state if a male fitting of the device is not inserted in the female fitting of the third port, the pinch valve is configured to be in a first position if the apparatus is in the first state, at least a top portion of the plug of the pinch valve is configured to extend into the third port in a direction away from the central passage and block a first fluid path when the pinch valve is in the first position, and the pinch valve is configured to not block a second fluid path when the pinch valve is in the first position;
the first fluid path is between the first port and the third port and passes through the opening in the tube;
the second fluid path is between the first port and the second port and passes through the tube;
the apparatus is configured to be in a second state if the male fitting of the device is fully inserted in the female fitting of the third port, the pinch valve is configured to be in a second position if the apparatus is in the second state, the pinch valve is configured to connect the first fluid path in the second position, and the pusher of the pinch valve is configured to push down on the tube and block the second fluid path when the pinch valve is in the second position; and
the apparatus is configured such that inserting the male fitting into the female fitting of the third port causes the apparatus to transition from the first state to the second state.

2. The apparatus of claim 1, wherein the pusher comprises a stem and an engagement portion, and the engagement portion is configured to push down on the tube and block the second fluid path when the pinch valve is in the second position.

3. The apparatus of claim 2, wherein the stem of the pusher extends into the plug.

4. The apparatus of claim 2, wherein the engagement portion is a tapered engagement portion.

5. The apparatus of claim 2, wherein the plug covers a top surface of the stem.

6. The apparatus of claim 2, wherein the plug does not cover a top surface of the stem.

7. The apparatus of claim 6, wherein the plug is configured such that, when the male fitting of the device is inserted in the female fitting of the third port, the male fitting of the device pushes on the stem and does not push directly on the plug.

8. The apparatus of claim 2, wherein the plug comprises an elastomer, and the stem comprises rigid material.

9. The apparatus of claim 1, wherein the body comprises one or more guides configured to guide movement of the pusher when the apparatus transitions from the first state to the second state.

10. The apparatus of claim 1, further comprising a spring configured to bias the pinch valve toward the first position of the pinch valve.

11. The apparatus of claim 10, wherein:
the body comprises one or more projections;
the pinch valve comprises a flange including a surface that faces away from the third port; and
when the pinch valve is in the second position, the spring is compressed between the one or more projections and the flange of the pinch valve.

12. The apparatus of claim 1, wherein the tube is configured to bias the pinch valve toward the first position of the pinch valve.

13. The apparatus of claim 1, wherein, when the pinch valve is in the second position, a top of the plug is below a thread on an external surface of the female fitting of the third port in a direction toward the central passage.

14. The apparatus of claim 1, wherein a top surface of the plug is uneven, and the uneven top surface of the plug is configured to facilitate connection of the first fluid path when the pinch valve is in the second position.

15. The apparatus of claim 1, wherein a bottom of the third port comprises a slanted surface configured to facilitate the first fluid path.

16. The apparatus of claim 1, wherein the first and second fluid paths are bi-directional.

17. A method for controlling fluid flow using an apparatus comprising a first port, a second port, a third port, a body comprising a central passage, a tube, and a pinch valve comprising a plug and a pusher, the method comprising:
connecting the first port to a first channel;
connecting the second port to a second channel; and
connecting the third port to a device defining a third channel, the third port comprising a female fitting, and connecting the third port to the device comprises fully inserting a male fitting of the device into the female fitting of the third port;
wherein:
the first port, the second port, and the third port are connected to each other via the central passage;
the tube extends from the first port to the second port through the central passage of the body;
a portion of the tube in the central passage comprises an opening;
the apparatus is in a first state before the third port is connected to the device;
the pinch valve is configured to be in a first position if the apparatus is in the first state;
the apparatus is configured to be in a second state if the male fitting of the device is fully inserted in the female fitting of the third port;
the pinch valve is configured to be in a second position if the apparatus is in the second state;
connecting the third port to the device causes the apparatus to transition from the first state to the second state;
when the pinch valve is in the first position, at least a top portion of the plug of the pinch valve extends into the third port in a direction away from the central passage and block a first fluid path that is between the first port and the third port and passes through the opening in the tube;
when the pinch valve is in the first position, the pinch valve does not block a second fluid path that is between the first port and the second port and passes through the tube;
when the pinch valve is in the second position, the pinch valve connects the first fluid path;
when the pinch valve is in the second position, the pusher of the pinch valve pushes down on the tube and blocks the second fluid path.

18. The method of claim 17, further comprising using one or more guides of the body to guide movement of the pusher when the apparatus transitions from the first state to the second state.

19. The method of claim 17, further comprising using a spring and/or the tube to bias the pinch valve toward the first position of the pinch valve.

20. The method of claim 17, further comprising using an uneven top surface of the plug to facilitate connection of the first fluid path when the pinch valve is in the second position.
